(19) United States
(12) Patent Application Publication
(10) Pub. No.: US 2009/0101624 A1
(43) Pub. Date: Apr. 23, 2009

(54) Method for manufacturing magnetic recording medium

(75) Inventors: Takahiro Suwa, Tokyo (JP); Narutoshi Fukuzawa, Tokyo (JP); Kazuhiro Hattori, Tokyo (JP); Shuichi Okawa, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/285,935

(22) Filed: Oct. 16, 2008

(30) Foreign Application Priority Data
Oct. 19, 2007 (JP) 2007-272851

(51) Int. Cl. B44C 1/22

(52) U.S. Cl. 216/22

(57) ABSTRACT

A method for efficiently manufacturing a magnetic recording medium by filling concave portions of a concavo-convex patterned recording layer with a filler to provide sufficient surface flatness is provided. A cladding is etched by a dry etching method in which an etch rate of the cladding is equal to or higher than an etch rate of the filler. Then, by dry etching method in which an etch rate of the filler is higher than that of the cladding, the filler is etched so that a top surface of a diaphragm over a recording element (or a top surface of the recording element in absence of the diaphragm) is exposed, and the cladding remains over the concave portion of the concavo-convex pattern of the recording layer.

### BACKGROUND OF THE INVENTION

1. Field of the Invention

The present invention relates to a method for manufacturing a magnetic recording medium having a recording layer formed in a concavo-convex pattern.

2. Description of the Related Art

Conventional magnetic recording media such as hard disks have been significantly improved in areal density, for example, by employing finer magnetic grains or alternative materials for the recording layer and advanced processing for magnetic heads. Although further improvements in areal density are still in demand, these conventional approaches to the improvement of areal density have already reached their limits due to several problems that have come to the surface. These problems include the limited accuracy of processing of magnetic heads, erroneous recording of information onto tracks adjacent to the target track due to spread of a recording magnetic field produced by the magnetic head, and crosstalk during reading operations.

In contrast to this, as candidate magnetic recording media that enable further improvements in areal density, discrete track media or patterned media have been suggested, in which their recording layers are formed in a concavo-convex pattern and the convex portions of the concavo-convex pattern constitute recording elements. On the other hand, for magnetic recording media such as hard disks, prime importance is placed on their surface flatness in order to stabilize the flying height of the head and thereby provide good recording/reproducing properties. In this context, it is preferable to fill the concave portions between the recording elements with a filler and then remove excessive filler above the recording layer, thereby flattening the top surfaces of the recording elements and the filler. As the filler, it has been suggested to use SiO₂ or DLC (Diamond Like Carbon), which is non-magnetic and has a high hardness (for example, see Japanese Patent Application Laid-Open No. 2003-109210). It should be noted that the DLC is also used as a material of the protective film for magnetic recording media.

The SiO₂ filler can be deposited to fill in the concave portion, for example, by sputtering. On the other hand, the DLC filler can be deposited to fill in the concave portion, for example, by CVD (Chemical Vapor Deposition). Excessive filler can be removed to flatten the surfaces, for example, by Chemical Mechanical Polishing (CMP) or dry etching (for example, see Japanese Patent Application Laid-Open No. 2000-195042). It should be noted that since the high hardness of DLC makes it difficult to remove the DLC filler by CMP, an excessive portion of the DLC filler is preferably removed by dry etching. Further, an excessive portion of any filler such as SiO₂ other than DLC can also be removed by dry etching. The filler is deposited in a concavo-convex pattern following the recording layer in a concavo-convex pattern, while in general, the dry etching tends to selectively etch the convex portion faster than the concave portion.

However, some filler materials (for example, a material like DLC) may not be selectively etched by dry etching faster at the convex portion than at the concave portion. Accordingly, when the deposited filler has a greater difference in height between the surfaces of the concave and convex portions, the surfaces sometimes cannot be flattened sufficiently even after removing the excessive fillet by dry etching.

It should be noted that the filler deposited over the recording layer in a concavo-convex pattern tends to gradually decrease in the height difference between the surfaces of the concave and convex portions as the thickness of the film (filler) deposited increases. It is thus possible to deposit the filler to a greater thickness, thereby reducing the height difference between the surfaces of the concave and convex portions of the filler deposited. However, depositing the filler to a greater thickness requires more time for depositing the filler and removing excessive filler, resulting in lower efficiency and productivity. This also requires an additional amount of filler. This eventually leads to an increase in costs for the magnetic recording medium as a whole.

Furthermore, depositing a material like DLC to a greater thickness also causes, for example, the deposited filler to be separated from the surface of the workpiece, or the filler adhered to the surface of the workpiece with difficulty, so that the filler is not deposited on part of the workpiece.

Furthermore, depositing the filler to a greater thickness also causes an increase in the amount of excessive filler accumulated over the recording layer. This in turn may cause an increase in maintenance costs to dispose of the filler removed from the workpiece or to remove the filler adhered to the vacuum chamber.

### SUMMARY OF THE INVENTION

In view of the foregoing problems, various exemplary embodiments of this invention provide a method for efficiently manufacturing a magnetic recording medium by filling the concave portions of a recording layer in a concavo-convex pattern with a filler to provide sufficient surface flatness.

To achieve the aforementioned object, various exemplary embodiments of the present invention provide a method for manufacturing a magnetic recording medium. The method includes the steps of: depositing a filler over a workpiece to fill a concave portion of a predetermined concavo-convex pattern with the filler, the workpiece having a substrate and a recording layer, the recording layer being formed in the concavo-convex pattern over the substrate so that a convex portion of the concavo-convex pattern constitutes a recording element; depositing a cladding on the filler; etching the cladding until the filler over the recording element is exposed; etching the cladding by a dry etching method in which an etch rate of the cladding is equal to or higher than an etch rate of the filler; and etching the filler by a dry etching method in which an etch rate of the filler is higher than an etch rate of the cladding, so that a top surface of the recording element is exposed and the cladding remains over the concave portion of the concavo-convex pattern.

Alternatively, to achieve the aforementioned object, various exemplary embodiments of the present invention provide a method for manufacturing a magnetic recording medium. The method includes the steps of: depositing a filler over a workpiece to fill a concave portion of a predetermined concavo-convex pattern with the filler, the workpiece having a substrate, a recording layer, and a diaphragm, the recording layer being formed in the concavo-convex pattern over the substrate so that a convex portion of the concavo-convex pattern constitutes a recording element, the diaphragm being formed at least over a top surface of the recording element in the recording layer; depositing a cladding on the filler; etching the cladding until the filler over the recording element is exposed; etching the cladding by a dry etching method in which an etch rate of the cladding is equal to or higher than an etch rate of the filler; and etching the filler by a dry etching method in which an etch rate of the filler is higher than an etch rate of the cladding, so that a top surface of the diaphragm over the recording element is exposed and the cladding remains over the concave portion of the concavo-convex pattern.

As described above, the cladding is first etched until the filler over the recording element is exposed, and the cladding is further etched by the dry etching method in which an etch rate of the cladding is equal to or higher than an etch rate of the filler. Then, the filler is etched by the dry etching method in which an etch rate of the filler is higher than an etch rate of the cladding, so that the top surface of the recording element (or the top surface of the diaphragm over the recording element) is exposed and the cladding remains over the concave portion of the concavo-convex pattern, thereby removing the filler over the recording element. This makes it possible to remove the excessive filler over the recording element while keeping the concave portion of the concavo-convex pattern filled with the filler, thereby allowing for flattening the surface with efficiency.

Accordingly, various exemplary embodiments of this invention provide a method for manufacturing a magnetic recording medium, comprising: a filler deposition step of depositing a filler over a workpiece to fill a concave portion of a predetermined concavo-convex pattern with the filler, the workpiece having a substrate and a recording layer, the recording layer being formed in the concavo-convex pattern over the substrate so that a convex portion of the concavo-convex pattern constitutes a recording element; a cladding deposition step of depositing a cladding on the filler; a preliminary cladding etching step of etching the cladding until the filler over the recording element is exposed; a main cladding etching step of etching the cladding by a dry etching method in which an etch rate of the cladding is equal to or higher than an etch rate of the filler; and a filler etching step of etching the filler by a dry etching method in which an etch rate of the filler is higher than an etch rate of the cladding, so that a top surface of the recording element is exposed and the cladding remains over the concave portion of the concavo-convex pattern.

Alternatively, various exemplary embodiments of this invention provide a method for manufacturing a magnetic recording medium, comprising: a filler deposition step of depositing a filler over a workpiece and filling a concave portion of a predetermined concavo-convex pattern with the filler, the workpiece having a substrate, a recording layer, and a diaphragm, the recording layer being formed in the concavo-convex pattern over the substrate so that a convex portion of the concavo-convex pattern constitutes a recording element, the diaphragm being formed at least over a top surface of the recording element in the recording layer; a cladding deposition step of depositing a cladding on the filler; a preliminary cladding etching step of etching the cladding until the filler over the recording element is exposed; a main cladding etching step of etching the cladding by a dry etching method in which an etch rate of the cladding is equal to or higher than an etch rate of the filler; and a filler etching step of etching the filler by a dry etching method in which an etch rate of the filler is higher than an etch rate of the cladding, so that a top surface of the diaphragm over the recording element is exposed and the cladding remains over the concave portion of the concavo-convex pattern.

In the description of the present application, the phrase “a recording layer formed in a concavo-convex pattern” does not only refer to a recording layer in which a continuous recording layer is divided in a predetermined pattern so that the convex portions constituting the recording elements are completely separated from one another, but shall also cover the following: a recording layer in which the convex portions that are separated from one another in the data region are continuous in the vicinity of the boundary between the data region and the servo region; a recording layer, such as a helical or spiral one, which is formed continuously on part of the substrate; a recording layer which is separately formed on the top surface of a convex portion and the bottom surface of a concave portion of an underlying layer formed in a concavo-convex pattern, so that the portion formed on the top surface of the convex portion constitutes the recording element; a recording layer in which the concave portion is formed half way in the direction of thickness and continuous at the bottom portion; and a continuous-film recording layer which is deposited in a concavo-convex pattern following an underlying layer formed in concavo-convex pattern.

In the description of the present application, the term “DLC” is used to refer to a material which is mainly composed of carbon and has SP³ hybrid orbital carbon bonds. The expression, “a material mainly composed of carbon” refers to a material whose ratio of the number of carbon atoms to the total number of atoms that constitute the material is 50% or more.

Moreover, in the description of the present application, the term “the magnetic recording medium” refers not only to hard disks, floppy (registered trademark) disks, or magnetic tapes, which employ only magnetism for recording and reproducing information, but also to magneto-optical storage media such as MOs (Magneto Optical), which employ both magnetism and light, and heat-assisted storage media which employ both magnetism and heat.

### BRIEF DESCRIPTION OF THE DRAWINGS

FIG. 1 is a schematic cross-sectional view illustrating the structure of a starting body of a workpiece in a manufacturing steps of a magnetic recording medium according to a first exemplary embodiment of the present invention;

FIG. 2 is a radially cross-sectional schematic view illustrating the structure of a magnetic recording medium obtained by processing the workpiece;

FIG. 3 is an enlarged radially cross-sectional view illustrating a recording layer and its surrounding structure in the magnetic recording medium;

FIG. 4 is a flowchart showing the outline of the manufacturing steps of the magnetic recording medium;

FIG. 5 is a radially cross-sectional schematic view illustrating the shape of the workpiece which has a resin layer in a concavo-convex pattern formed thereon;

FIG. 6 is a radially cross-sectional schematic view illustrating the shape of the workpiece in which a recording layer and diaphragm have been processed in a concavo-convex pattern;

FIG. 7 is a radially cross-sectional schematic view illustrating the shape of the workpiece which has a filler deposited over the diaphragm;

FIG. 8 is a radially cross-sectional schematic view illustrating the shape of the workpiece which has a cladding deposited on the filler;

FIG. 9 is a radially cross-sectional schematic view illustrating the shape of the workpiece where the cladding has been etched to make the filler over a recording element exposed;

FIG. 10 is a radially cross-sectional schematic view illustrating the shape of the workpiece where the filler over the recording element has been etched;

FIG. 11 is a radially cross-sectional schematic view illustrating the shape of the workpiece where the cladding remaining over the concave portion and the diaphragm over the recording element have been etched to make the surface flattened;

FIG. 12 is a schematic cross-sectional view illustrating the structure of a starting body of a workpiece in a manufacturing steps of a magnetic recording medium according to a second exemplary embodiment of the present invention;

FIG. 13 is a radially cross-sectional schematic view illustrating the structure of the magnetic recording medium obtained by processing the workpiece;

FIG. 14 is an enlarged radially cross-sectional view illustrating a recording layer and its surrounding structure in the magnetic recording medium;

FIG. 15 is a flowchart showing the outline of the manufacturing steps of the magnetic recording medium;

FIG. 16 is a radially cross-sectional schematic view illustrating the shape of the workpiece in which a recording layer has been processed in a concavo-convex pattern;

FIG. 17 is a radially cross-sectional schematic view illustrating the shape of the workpiece where a diaphragm has been deposited over the recording layer;

FIG. 18 is a radially cross-sectional schematic view illustrating the shape of the workpiece which has a filler deposited over the diaphragm;

FIG. 19 is a radially cross-sectional schematic view illustrating the shape of the workpiece which has a cladding deposited on the filler;

FIG. 20 is a radially cross-sectional schematic view illustrating the shape of the workpiece where the cladding has been etched to make the filler over a recording element exposed;

FIG. 21 is a radially cross-sectional schematic view illustrating the shape of the workpiece where the filler over the recording element has been etched;

FIG. 22 is a radially cross-sectional schematic view illustrating the shape of the workpiece where the cladding remaining over the concave portion and the diaphragm over the recording element have been etched to make the surface flattened;

FIG. 23 is a radially cross-sectional schematic view illustrating the shape of a workpiece where a filler has been deposited over a recording layer in a manufacturing steps of a magnetic recording medium according to a third exemplary embodiment of the present invention;

FIG. 24 is a radially cross-sectional schematic view illustrating the shape of the workpiece which has a cladding deposited on the filler;

FIG. 25 is a radially cross-sectional schematic view illustrating the shape of the workpiece where the cladding has been etched to make the filler over a recording element exposed;

FIG. 26 is a radially cross-sectional schematic view illustrating the shape of the workpiece where the filler over the recording element has been etched;

FIG. 27 is a radially cross-sectional schematic view illustrating the shape of the workpiece where the cladding remaining over the concave portion and the vicinity of the top surface of the recording element have been etched to make the surface flattened; and

FIG. 28 is a flowchart showing the outline of a manufacturing steps of a magnetic recording medium according to a fourth exemplary embodiment of the present invention.

### DETAILED DESCRIPTION OF THE PREFERRED EMBODIMENTS

Now, preferred exemplary embodiments of the present invention will be described below in more detail with reference to the accompanying drawings.

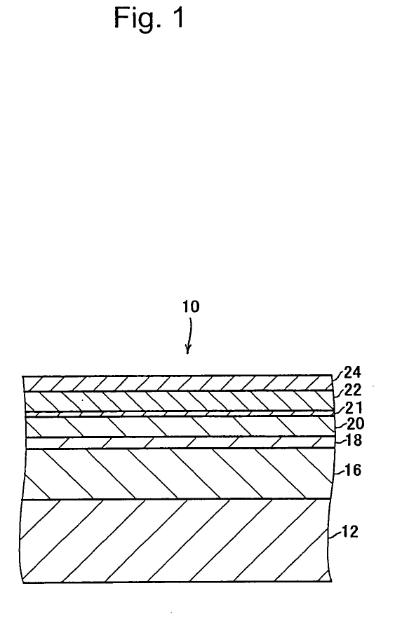

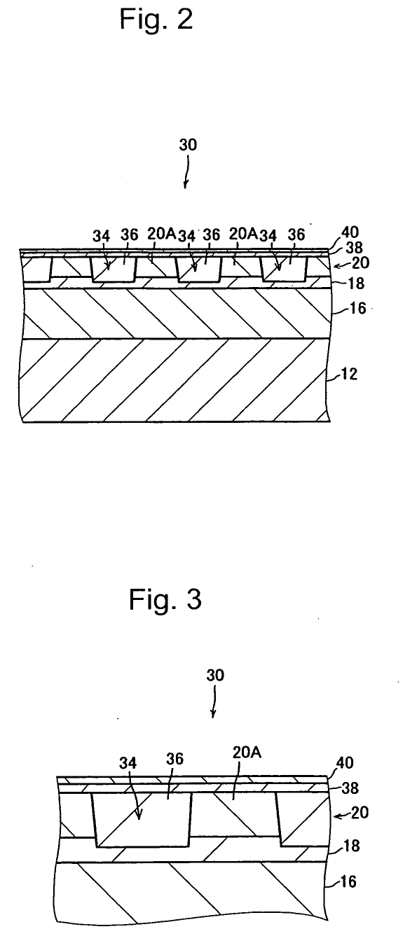

A first exemplary embodiment of the present invention relates to a method for manufacturing a magnetic recording medium. In the method, a starting body of a workpiece 10 shown in FIG. 1 is processed by dry etching or the like, so that a recording layer of a continuous film is processed in the shape of a predetermined line and space pattern (data track pattern) as shown in FIGS. 2 and 3 and a servo pattern (not shown). The method is characterized by a technique for filling the concave portion of a recording layer in a concavo-convex pattern with a filler to flatten the surface. Other techniques are not thought to be particularly inevitable for the understanding of the first exemplary embodiment and therefore will be omitted in the following descriptions as appropriate.

As shown in FIG. 1, the starting body of the workpiece 10 is configured to include a substrate 12, a soft magnetic layer 16, a seed layer 18, a recording layer 20 of a continuous film, a diaphragm 21, a first mask layer 22, and a second mask layer 24, all of which are formed over the substrate 12 in that order.

The substrate 12 is a disk generally circular in shape. The substrate 12 can be made of glass, Al, Al₂O₃ or the like.

The soft magnetic layer 16 has a thickness of 50 to 300 nm. The soft magnetic layer 16 can be made of a Fe alloy, a Co alloy or the like.

The seed layer 18 has a thickness of 2 to 40 nm. The seed layer 18 can be made of a non-magnetic CoCr alloy, Ti, Ru, a stacked body of Ru and Ta, MgO or the like.

The recording layer 20 has a thickness of 5 to 30 nm. The recording layer 20 can be made of, for example, a CoCr base alloy such as CoCrPt alloy, a FePt base alloy, a stacked body of them, a material containing ferromagnetic grains such as CoPt in a matrix of an oxide base material such as SiO₂.

The diaphragm 21 has a thickness of 1 to 5 nm. The diaphragm 21 can be made of SiO₂, MgO, ITO (Indium Tin-doped Oxide), TaSi, Ti, TiN, TiO₂, SiC, DLC or the like. Furthermore, the diaphragm 21 can also be made of Si, Ge, C (carbon), Mn, Ta, Nb, Mo, Zr, W, Al, Ni, Cu, Cr, Co, or a compound of them.

The first mask layer 22 has a thickness of 3 to 50 nm. The first mask layer 22 can be made of C (carbon). The first mask layer 22 may also be made of DLC.

The second mask layer 24 has a thickness of 2 to 30 nm. The second mask layer 24 can be made of Ni, Cu, Cr, Al, Al₂O₃, Ta or the like.

A magnetic recording medium 30 is a disc-shaped perpendicular recording type discrete track medium. As shown in FIGS. 2 and 3, the recording layer 20 is formed in the concavo-convex pattern so that the recording layer 20 of a continuous film mentioned above is divided radially at fine intervals in a data region into multiple concentric arcuate recording elements 20A. It should be noted that in a servo region, the recording layer 20 is divided into multiple recording elements in a predetermined servo pattern (not shown). A concave portion 34 between the recording elements 20A is filled with a filler 36. A protective layer 38 and a lubricant layer 40 are formed over the recording elements 20A and the filler 36 in that order.

As the filler 36, it is possible to use DLC, SiO₂, SiC, MgO, ITO, TaSi, TiN, TiO₂ or the like. As the filler 36, it is also possible to use Si, Ge, C (carbon), Ta, Ti, Nb, Mo, Zr, W, Al, Mn, Ni, Cu, Cr, Co, and a compound of them. The DLC includes, for example, tetrahedral amorphous carbon containing no hydrogen, amorphous carbon containing hydrogen, a mixture of them, or one which partially or locally has a structure like polyethylene or polyacetylene. It should be noted that the filler 36 is made of a material which is different from that of the diaphragm 21.

The protective layer 38 has a thickness of 1 to 5 nm. The protective layer 38 can be made of DLC. It should be noted that if the filler 36 is made of DLC, the protective layer 38 and the filler 36 may be made of different types of DLCs or the same type of DLC. For example, it is acceptable to use DLCs whose rates of SP³ hybrid orbital carbon bonds are different from each other.

The lubricant layer 40 has a thickness of 1 to 2 nm. The lubricant layer 40 can be made of PFPE (perfluoropolyether).

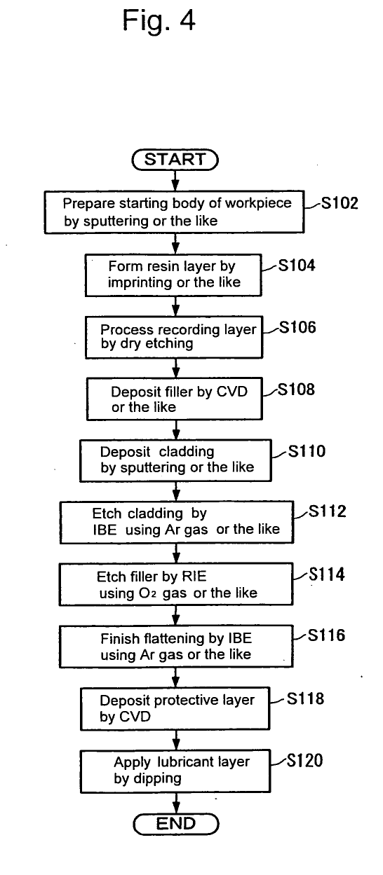

Now, with reference to the flowchart shown in FIG. 4, a description will be made to a method for manufacturing the magnetic recording medium 30.

First, a starting body of the workpiece 10 shown in FIG. 1 is prepared (S102). The starting body of the workpiece 10 can be obtained by depositing the soft magnetic layer 16, the seed layer 18, the recording layer 20 (the continuous film that has not yet been processed in a concavo-convex pattern), the diaphragm 21, the first mask layer 22, and the second mask layer 24 by sputtering or the like in that order over the substrate 12.

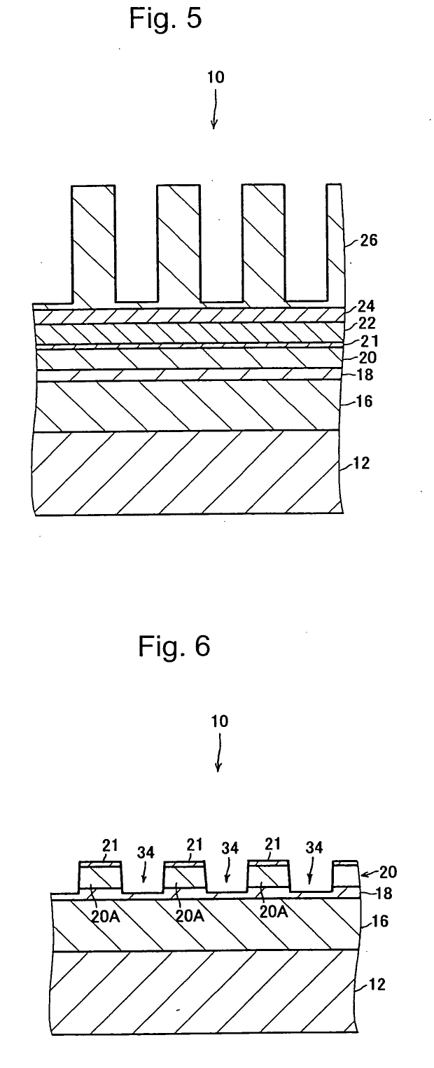

Then, as shown in FIG. 5, a resin material is applied over the second mask layer 24 of the workpiece 10 by spin coating. Subsequently, using a stamper (not shown), a concavo-convex pattern equivalent to the concavo-convex pattern of the recording layer 20 is transferred to the resin material by imprinting, thereby forming a resin layer 26 in a concavo-convex pattern (S104). For the imprinting, it is possible to employ, for example, optical imprinting with ultraviolet light or the like, or thermal imprinting. For the optical imprinting, a UV curable resin can be used as the material of the resin layer 26. On the other hand, for the thermal imprinting, a thermoplastic resin can be used as the material of the resin layer 26. For example, the resin layer 26 (i.e., the convex portion) has a thickness of 30 to 300 nm. It should be noted that the resin layer 26 having a concavo-convex pattern equivalent to the concavo-convex pattern of the recording layer 20 may also be formed by photolithography or electron-beam lithography using a photoresist or electron resist as the resin material.

Then, after removing by ashing the resin layer 26 at the bottom of the concave portion as required, the second mask layer 24 at the bottom of the concave portion is removed by IBE (Ion Beam Etching) using an Ar gas. Furthermore, the first mask layer 22 at the bottom of the concave portion is removed by RIE (Reactive Ion Etching) using an O₂ gas, and then the diaphragm 21 and the recording layer 20 at the bottom of the concave portion are removed by IBE using an Ar gas (S106). Up to this stage, the recording layer 20 in a concavo-convex pattern having been divided into the multiple recording elements 20A is formed as shown in FIG. 6. The diaphragm 21 remains over the recording elements 20A. That is, what is obtained is the workpiece 10 which has the diaphragm 21 formed over the top surface of the recording elements 20A. It should be noted that since the first mask layer 22 may remain over the diaphragm 21, the first mask layer 22 remaining over the diaphragm 21 is completely removed by RIE using an O₂ gas as the reactive gas.

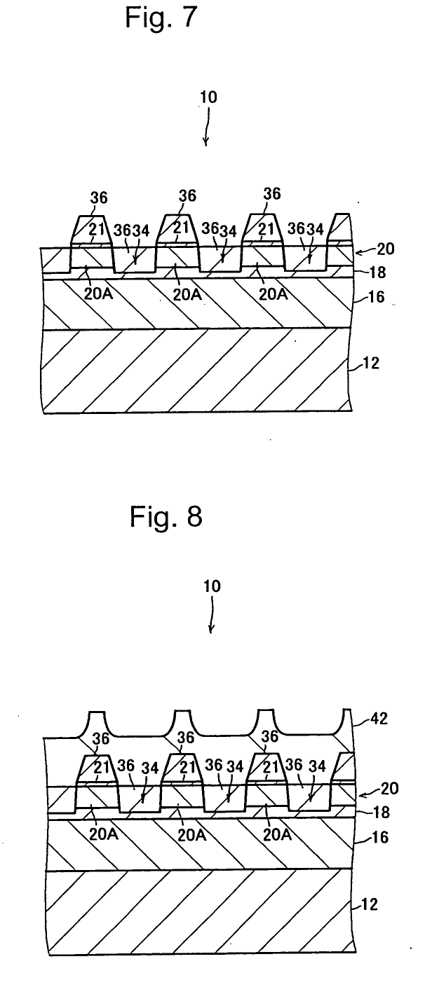

Then, as shown in FIG. 7, the filler 36 is deposited over the workpiece 10 to fill the concave portion 34 with the filler 36 (S108). When the filler 36 is DLC, the filler 36 is deposited over the workpiece 10 by CVD while a bias voltage is being applied to the workpiece 10. Methane, ethylene, toluene or the like can be used as the feed gas for CVD. If the filler 36 is made of a material other than DLC such as SiO₂, the filler 36 can be deposited over the workpiece 10 by another method such as sputtering or bias sputtering. The filler 36 is deposited in a concavo-convex pattern following the concavo-convex pattern of the recording layer 20. It should be noted that the phrase “being deposited in a concavo-convex pattern following the concavo-convex pattern of the recording layer 20” includes being deposited in a concavo-convex pattern which is increased or decreased in the width of the concave portion, the width of the convex portion, or the height difference between the concave and convex portions with respect to the concavo-convex pattern of the recording layer 20. The height of the top surface of the filler 36 that fills the concave portion 34 is preferably −6 to +6 nm relative to the height of the top surface of the recording elements 20A, and more preferably the height of the top surface of the filler 36 that fills the concave portion 34 is generally coincident with the height of the top surface of the recording elements 20A. “The height of the top surface of the filler 36” means the position of the top surface of the filler 36 in the direction of thickness of the substrate 12. The same also holds true for “the height of the top surface of the recording elements 20A.” Furthermore, the sign “−” means that the top surface of the filler 36 that fills the concave portion 34 is closer to the substrate 12 than the top surface of the recording elements 20A is. Furthermore, the sign “+” means that the top surface of the filler 36 that fills the concave portion 34 is farther from the substrate 12 than the top surface of the recording elements 20A is. Furthermore, the phrase “a height of the top surface of the filler 36 that fills the concave portion 34 is generally coincident with a height of the top surface of the recording elements 20A” means that the height difference between both the top surfaces lies within the range of ±4 nm.

Then, as shown in FIG. 8, a cladding 42 is deposited on the filler 36 of the workpiece 10 by sputtering or the like (S110). The cladding 42 to be deposited has a thickness of 10 to 70 nm. The cladding 42 can be made of the same material as that of the diaphragm 21. More specifically, it can be made of a material such as SiO₂, MgO, ITO, TaSi, TiN, TiO₂, SiC, or DLC. It is also possible to use, for example, Si, Ge, C (carbon), Mn, Ta, Ti, Nb, Mo, Zr, W, Al, Ni, Cu, Cr, or Co, or a compound of them.

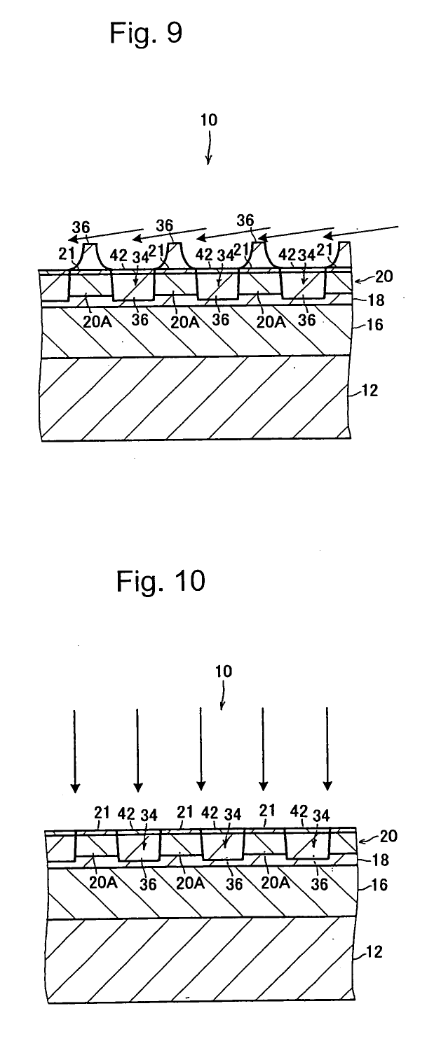

Then, by a dry etching method in which an etch rate of the cladding 42 is equal to or higher than an etch rate of the filler 36, the cladding 42 is etched until the filler 36 over the recording elements 20A is exposed (a preliminary cladding etching step). Furthermore, by the dry etching method in which an etch rate of the cladding 42 is equal to or higher than an etch rate of the filler 36, the cladding 42 is further etched (a main cladding etching step) (S112). In this step, the cladding 42 is etched preferably until the filler 36 over the recording elements 20A is substantially completely exposed. Furthermore, as shown in FIG. 9, it is preferable at the end of this step that the height of the top surface of the cladding 42 over the concave portion 34 of the concavo-convex pattern of the recording layer 20 is generally coincident with the height of the top surface of the diaphragm 21 over the recording elements 20A. It should be noted that the phrase “a height of the top surface of the cladding 42 is generally coincident with the height of the top surface of the diaphragm 21” means that the height difference between both the top surfaces lies within the range of ±4 nm. Examples of the dry etching method can include IBE and RIE using an inert gas such as Ar, Kr, or Xe as the process gas. It should be noted that as used herein, the term “RIE” also refers to etching using RIE equipment even when such a gas, like an inert gas, that does not chemically react with an object being etched is employed. The angle of incidence of the process gas is set, for example, at 2 degrees relative to the surface of the workpiece 10. It should be noted that as used herein, the phrase “an angle of incidence of the process gas” refers to the angle formed between the predominant direction of travel of the process gas and the surface of the workpiece. For example, if the predominant direction of travel of the process gas is parallel to the surface of the workpiece, then the angle of incidence is 0 degree. The arrows in FIG. 9 schematically illustrate the direction of incidence of the process gas. As such, setting the angle of incidence of the process gas at a small angle causes the convex portion to be readily etched faster than the concave portion, thereby allowing the filler 36 over the recording elements 20A to be more easily exposed from the cladding 42. It should be noted that the angle of incidence of the process gas may also be set, for example, at 90 degrees, that is perpendicular to the surface of the workpiece 10. This setting of the angle of incidence of the process gas to a larger angle allows for providing an increased etch rate, thereby contributing to improvement in efficiency and productivity. Furthermore, the RIE process gas travels less linearly than the IBE process gas, so that even when the angle of incidence of the RIE process gas is set at 90 degrees, i.e., perpendicular to the surface of the workpiece 10, some of the particles are directed to the workpiece in an inclined direction relative to the surface of the workpiece 10. Accordingly, the convex portion tends to be etched faster than the concave portion, thereby facilitating the filler 36 over the recording elements 20A to be exposed from the cladding 42. It should be noted that the height difference between the concave and convex portions on the surface of the cladding 42 is reduced as the etching proceeds.

Then, the filler 36 is etched by the dry etching method in which an etch rate of the filler 36 is higher than an etch rate of the cladding 42 and higher than an etch rate of the diaphragm 21. This etching is carried out so that, as shown in FIG. 10, the top surface of the diaphragm 21 over the recording elements 20A is exposed and the cladding 42 remains over the concave portion 34 of the concavo-convex pattern of the recording layer 20 (S114). It should be noted that the phrase “the cladding 42 remains over the concave portion 34 of the concavo-convex pattern of the recording layer 20” also includes such a case where some or whole of the cladding 42 remains in the concave portion 34 (or is located closer to the substrate 12 than to the top surface of the recording elements 20A in the concave portion 34). At the end of this step, it is preferable that the height of the top surface of the cladding 42 over the concave portion 34 of the concavo-convex pattern of the recording layer 20 be generally coincident with the height of the top surface of the diaphragm 21 over the recording elements 20A. The phrase “a height of the top surface of the cladding 42 is generally coincident with the height of the top surface of the diaphragm 21” means that the height difference between both the top surfaces lies within the range of ±4 nm. Furthermore, in this step, it is preferable that the cladding 42 over the concave portion 34 be not substantially etched. The cladding 42 remains as such over the concave portion 34 of the concavo-convex pattern of the recording layer 20 makes it possible to remove an excessive amount of the filler 36 above the recording elements 20A without etching the filler 36 inside the concave portion 34. As the dry etching method, IBE or RIE can be employed using the process gas such as an O₂ gas, O₃ gas, their plasma, or a gas mixture of any one of them and an inert gas such as Ar, Kr, or Xe. It should be noted that the angle of incidence of the process gas is set, for example, at 90 degrees or perpendicular to the surface of the workpiece 10. The arrows in FIG. 10 schematically illustrate the direction of incidence of the process gas.

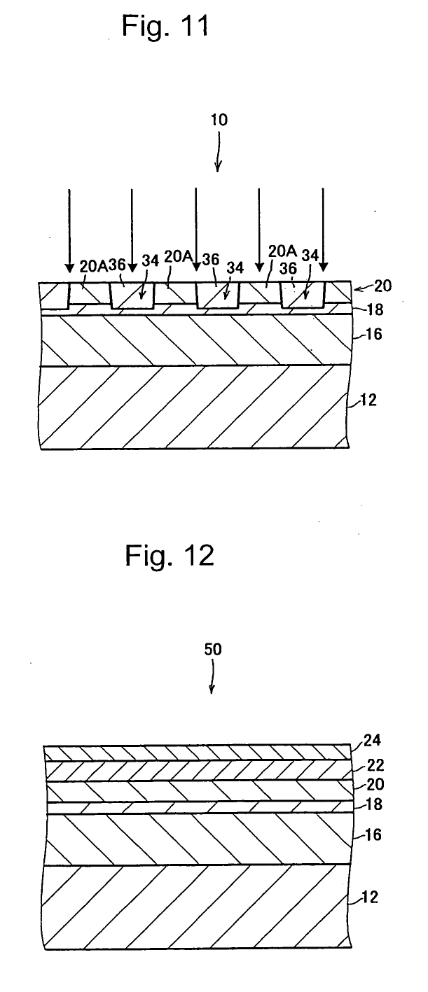

Then, as shown in FIG. 11, the cladding 42 and the diaphragm 21 are etched by dry etching to remove the cladding 42 remaining over the concave portion 34 and the diaphragm 21 over the recording elements 20A (S116). When the surface of the workpiece 10 has been sufficiently flattened at the end of the filler etching step (S114), the dry etching method may be well employed, in which an etch rate of the cladding 42 and an etch rate of the diaphragm 21 are generally equal to each other, and an etch rate of the filler 36 is lower than these etch rates. On the other hand, at the end of the filler etching step (S114), there may have occurred a height difference between the height of the top surface of the cladding 42 remaining over the concave portion 34 of the concavo-convex pattern of the recording layer 20 and the height of the top surface of the diaphragm 21 over the recording elements 20A. In this case, the dry etching method may be well employed, in which there is such a difference between an etch rate of the cladding 42 and an etch rate of the diaphragm 21 as to eliminate or sufficiently reduce the height difference, and an etch rate of the filler 36 is lower than these etch rates. The dry etching method can employ IBE or RIE using as the process gas, for example, an inert gas such as Ar, Kr, or Xe or a gas mixture of one of these and a reactive gas. It should be noted that the angle of incidence of the process gas is set, for example, at 90 degrees or perpendicular to the surface of the workpiece 10. The arrows in FIG. 11 schematically illustrate the direction of incidence of the process gas. Thus, the top surface of the recording elements 20A and the top surface of the filler 36 that fills the concave portion 34 are exposed, and made generally equal in height to each other. That is, the surface of the workpiece 10 is sufficiently flattened.

Then, the protective layer 38 is formed over the recording elements 20A and the filler 36 by CVD (S118). The lubricant layer 40 is further applied to the protective layer 38 by dipping (S120). In this manner, the magnetic recording medium 30 shown in FIGS. 2 and 3 is completed.

As described above, the filler 36 is deposited to such a thin layer that allows the height of the top surface of the filler 36 that fills the concave portion 34 to be generally coincident with the height of the top surface of the recording elements 20A (S108). Even in this case, the cladding 42 is further deposited on the filler 36 (S110), and then the cladding 42 is etched by the dry etching method in which the etch rate of the cladding 42 is equal to or higher than the etch rate of the filler 36 (S112). Then, by the dry etching method in which the etch rate of the filler 36 is higher than the etch rate of the cladding 42, the filler 36 is etched so that the top surface of the diaphragm 21 over the recording elements 20A is exposed and the cladding 42 remains over the concave portion 34 of the concavo-convex pattern of the recording layer 20. This allows for removing the excessive portion of the filler 36 above the recording elements 20A while keeping the concave portion 34 of the concavo-convex pattern of the recording layer 20 filled with the filler 36. It is thus possible to efficiency flatten the surface.

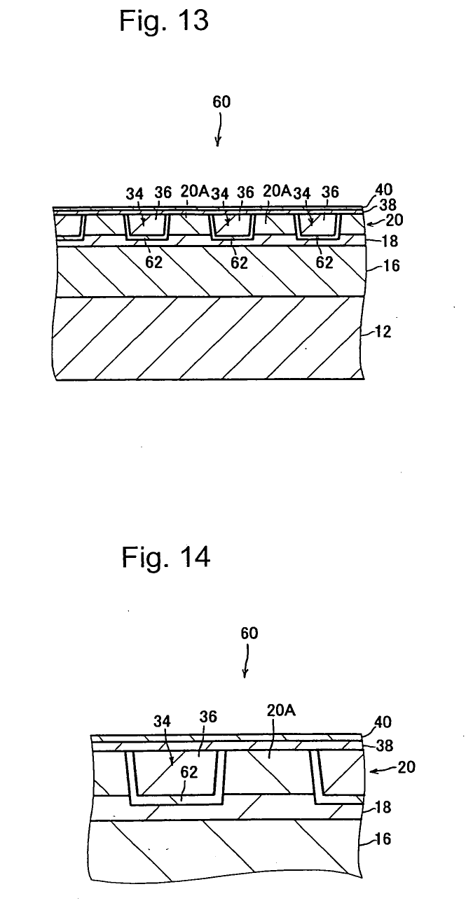

Now, a description will be made to a second exemplary embodiment of the present invention. In the first exemplary embodiment, when the starting body of the workpiece 10 was prepared, the diaphragm 21 was formed between the recording layer 20 (the continuous film that has not yet been processed in a concavo-convex pattern) and the first mask layer 22, and no diaphragm 21 remains in the magnetic recording medium 30. In contrast to this, as shown in FIG. 12, the starting body of a workpiece 50 according to the second exemplary embodiment has no diaphragm formed between the recording layer 20 and the first mask layer 22. Furthermore, as shown in FIGS. 13 and 14, a magnetic recording medium 60 according to the second exemplary embodiment has a diaphragm 62 formed on the bottom and side surfaces of the concave portion 34 of the concavo-convex pattern of the recording layer 20.

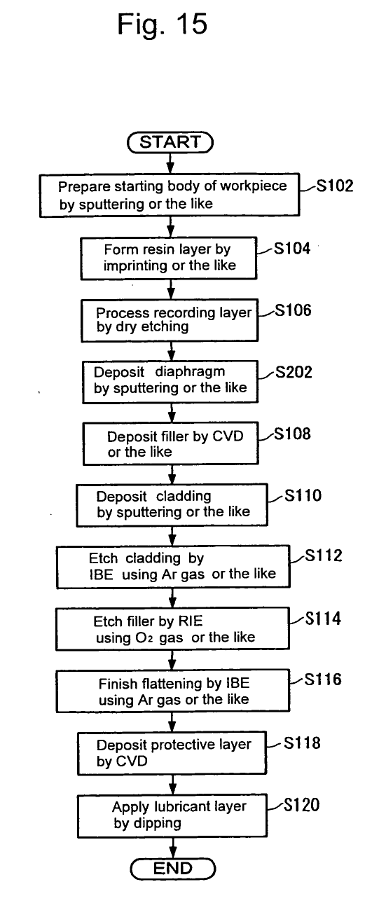

A description will now be made to a method for manufacturing the magnetic recording medium 60 following the flowchart of FIG. 15. It should be noted that since the method for manufacturing the magnetic recording medium 60 has a number of points in common with the method for manufacturing the magnetic recording medium 30 according to the first exemplary embodiment, those common points will be indicated with the same reference numerals as those of FIGS. 1 to 11 and their descriptions will be omitted where appropriate.

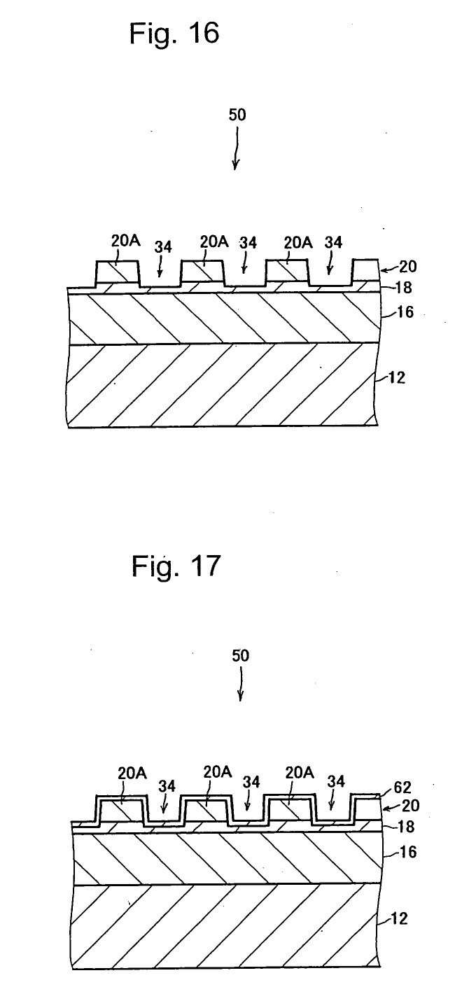

As in the first exemplary embodiment, the resin layer forming step (S104) and the recording layer processing step (S106) are performed on the starting body of the workpiece 50. As shown in FIG. 16, this allows for providing the workpiece 50 which has the recording layer 20 in a concavo-convex pattern divided into multiple recording elements 20A and no diaphragm formed over the recording elements 20A.

Then, as shown in FIG. 17, the diaphragm 62 is deposited over the recording layer 20 in a concavo-convex pattern by sputtering or the like (S202). It should be noted that the thickness and material of the diaphragm 62 may be the same as those of the diaphragm 21. The diaphragm 62 is formed in a concavo-convex pattern following the concavo-convex pattern of the recording layer 20. This allows for providing the workpiece 50 which has the diaphragm 62 formed over the top surface of the recording elements 20A. It should be noted that the diaphragm 62 is also formed on the bottom and side surfaces of the concave portion 34 of the concavo-convex pattern of the recording layer 20.

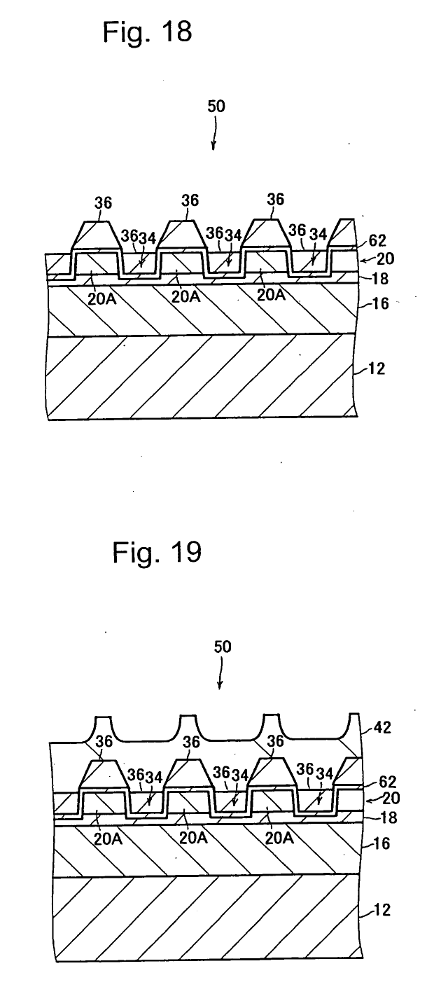

As shown in FIG. 18, the filler deposition step (S108) is performed on the workpiece 50, and as shown in FIG. 19, the cladding deposition step (S110) is further performed thereon.

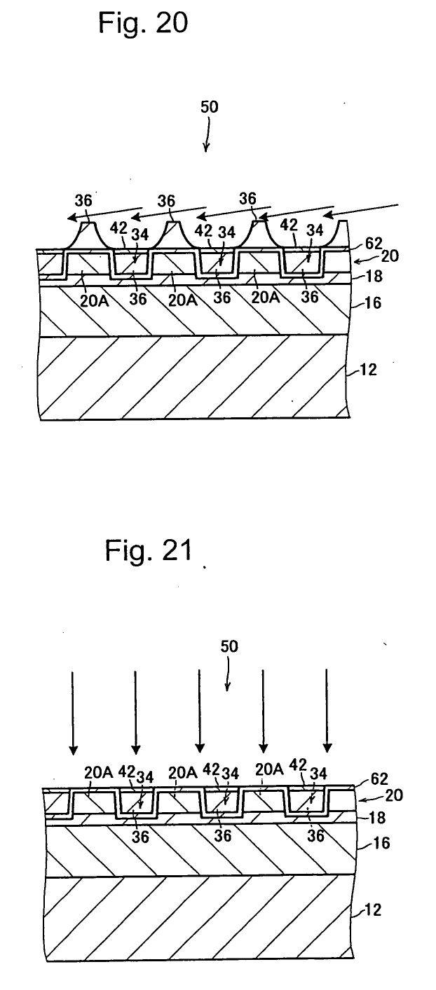

Then, as shown in FIG. 20, the cladding etching step (the preliminary cladding etching step and the main cladding etching step) (S112) is carried out, and then as shown in FIG. 21, the filler etching step (S114) is further performed. This allows the diaphragm 62 over the recording elements 20A to be exposed while the cladding 42 remains over the concave portion 34. It should be noted that at the end of the cladding etching step (S112) or the filler etching step (S114), the height of the top surface of the cladding 42 over the concave portion 34 of the concavo-convex pattern of the recording layer 20 is preferably generally coincident with the height of the top surface of the diaphragm 62 on the recording elements 20A.

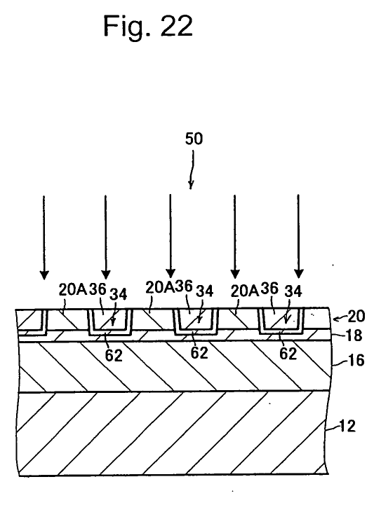

Then, as shown in FIG. 22, the cladding 42 and the diaphragm 62 are etched by the dry etching method in which an etch rate of the cladding 42 and an etch rate of the diaphragm 62 are generally equal to each other and an etch rate of the filler 36 is lower than these etch rates. This etching is performed to remove the cladding 42 remaining over the concave portion 34 and the diaphragm 62 over the recording elements 20A. (S116). This allows for exposing the top surface of the recording elements 20A and the top surface of the filler 36 that fills the concave portion 34, and as well making these heights generally equal to each other. That is, the surface of the workpiece 50 is sufficiently flattened.

The protective layer deposition step (S118) and the lubricant layer deposition step (S120) are further performed, thereby providing the magnetic recording medium 60 shown in FIGS. 13 and 14.

Now, a description will be made to a third exemplary embodiment of the present invention. In the first and second exemplary embodiments, the diaphragm 21 or 62 was formed over the recording layer 20 to manufacture the magnetic recording medium 30 or 60. In contrast to this, the third exemplary embodiment is adapted such that a magnetic recording medium 10 that has the same configuration as that according to the first exemplary embodiment is manufactured but with no diaphragm formed over the recording layer 20. It should be noted that since the manufacturing method of the third exemplary embodiment has a number of points in common with the manufacturing method of the first and second exemplary embodiments, those common points will be indicated with the same reference numerals as those of FIGS. 1 to 22 and their descriptions will be omitted where appropriate.

First, as in the second exemplary embodiment, the resin layer forming step (S104) and the recording layer processing step (S106) are performed on the starting body of the workpiece 50 in the same manner as in the first exemplary embodiment. As shown in FIG. 16, this allows for providing the workpiece 50 which has the recording layer 20 in a concavo-convex pattern divided into multiple recording elements 20A and no diaphragm formed over the recording elements 20A.

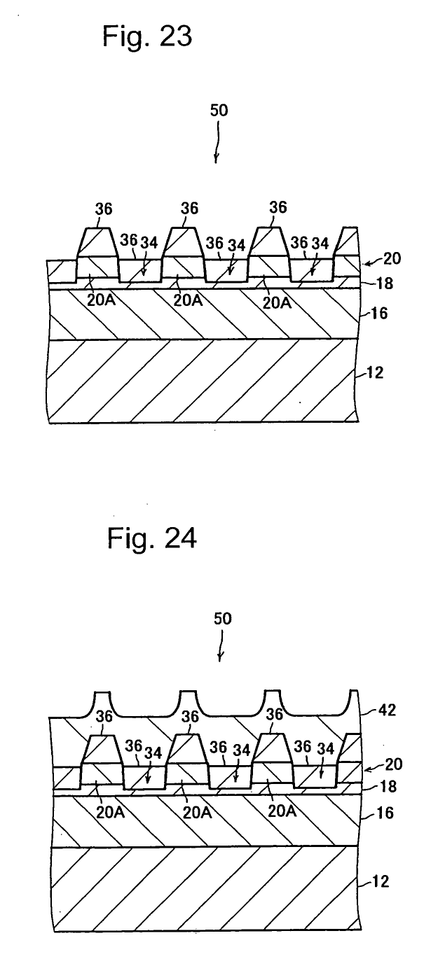

Then, as shown in FIG. 23, the filler deposition step (S108) is performed on the workpiece 50. The height of the top surface of the filler 36 that fills the concave portion 34 of the concavo-convex pattern of the recording layer 20 is preferably −6 to +6 nm relative to the height of the top surface of the recording elements 20A, and more preferably −6 to +1 nm. Still more preferably, the top surface of the filler 36 that fills the concave portion 34 of the concavo-convex pattern of the recording layer 20 within this range is recessed toward the substrate 12 with respect to the top surface of the recording elements 20A. Furthermore, as shown in FIG. 24, the cladding deposition step (S110) is performed.

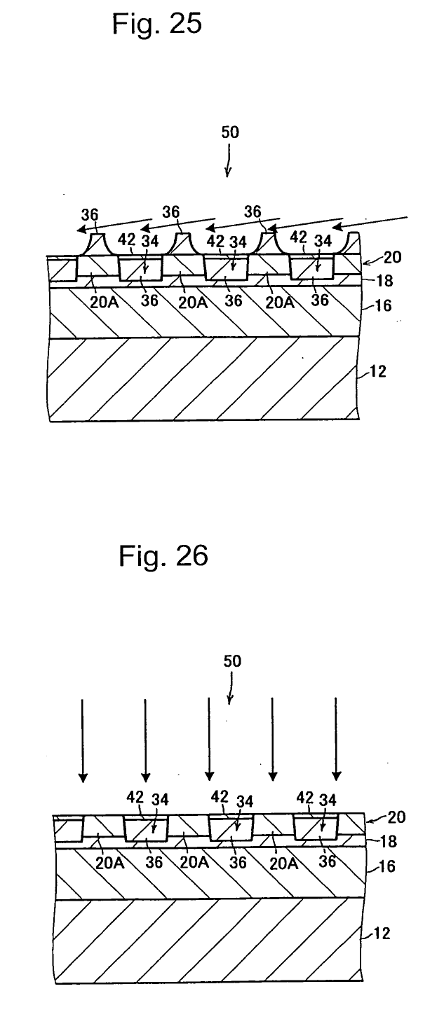

Then, as shown in FIG. 25, the cladding etching step (the preliminary cladding etching step and the main cladding etching step) (S112) are performed. At the end of this step, the height of the top surface of the cladding 42 over the concave portion 34 of the concavo-convex pattern of the recording layer 20 is preferably generally coincident with the height of the top surface of the recording elements 20A. The phrase “the height of the top surface of the cladding 42 is generally coincident with the height of the top surface of the recording elements 20A” means that the height difference between both the top surfaces lies within the range of ±4 nm.

Then, as shown in FIG. 26, the filler etching step (S114) is performed. This allows the recording elements 20A to be exposed while the cladding 42 remains over the concave portion 34 of the concavo-convex pattern of the recording layer 20. At the end of this step, the height of the top surface of the cladding 42 over the concave portion 34 of the concavo-convex pattern of the recording layer 20 is preferably generally coincident with the height of the top surface of the recording elements 20A.

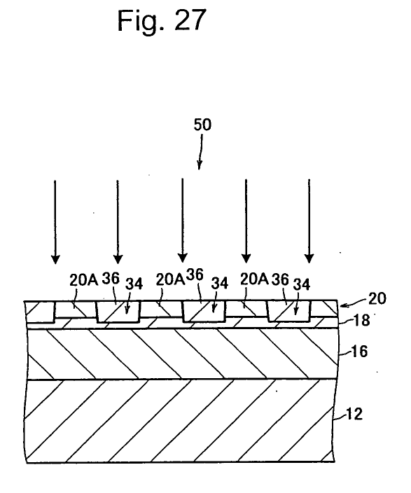

Then, as shown in FIG. 27, the cladding 42 and the recording elements 20A are etched by dry etching to remove the cladding 42 remaining over the concave portion 34 of the concavo-convex pattern of the recording layer 20 and the vicinity of the top surface of the recording elements 20A (S116). When the surface of the workpiece 50 has been sufficiently flattened at the end of the filler etching step (S114), the dry etching method may be well employed, in which an etch rate of the cladding 42 and an etch rate of the recording layer 20 are generally equal to each other and an etch rate of the filler 36 is lower than these etch rates. On the other hand, at the end of the filler etching step (S114), there may have occurred a height difference between the height of the top surface of the cladding 42 remaining over the concave portion 34 of the concavo-convex pattern of the recording layer 20 and the height of the top surface of the recording elements 20A. In this case, the dry etching method may be well employed, in which there is such a difference between an etch rate of the cladding 42 and an etch rate of the recording layer 20 as to eliminate or sufficiently reduce the height difference, and an etch rate of the filler 36 is lower than these etch rates. The dry etching method can employ IBE or RIE using as the process gas, for example, an inert gas such as Ar, Kr, or Xe, or a gas mixture of one of these and a reactive gas. In this manner, the top surface of the filler 36 10 that fills the concave portion 34 is exposed, and the height of the top surface of the filler 36 and the height of the top surface of the recording elements 20A are made generally equal to each other. That is, the surface of the workpiece 50 is sufficiently flattened. It should be noted that since no diaphragm is formed over the recording layer 20, there is a possibility that a change in quality may occur in the vicinity of the top surface of the recording element due to processing such as removing the first mask layer over the recording layer 20. However, even in the presence of such a change in quality, the portion having been changed in quality in the vicinity of the top surface of the recording elements 20A is removed in this step (S116), thereby preventing deterioration in magnetic property.

The protective layer deposition step (S118) and the lubricant layer deposition step (S120) are further performed, thereby providing the magnetic recording medium 30 shown in FIGS. 2 and 3.

In the first to third exemplary embodiments, it is stated that at the end of the cladding etching step (S112), the height of the top surface of the cladding 42 over the concave portion 34 of the concavo-convex pattern of the recording layer 20 was preferably generally coincident with the height of the top surface of the diaphragm 21 (62) over the recording elements 20A or the height of the top surface of the recording elements 20A. However, the cladding etching step (S112) may also be finished without the heights of these top surfaces being coincident with each other, and the heights of these top surfaces may be made generally coincident with each other at the end of the filler etching step (S114).

Furthermore, as an example of the dry etching method used in the cladding etching step (S112) in the first to third exemplary embodiments, the IBE or RIE is shown which uses an inert gas such as Ar, Kr, or Xe as the process gas. However, it is also possible to use another dry etching method if it allows the etch rate of the cladding 42 to be equal to or higher than the etch rate of the filler 36.

Table 1 shows a preferable combination between the materials for the filler 36, the cladding 42, and the diaphragm 21 and the process gas for dry etching in the cladding etching step (S112).

TABLE 1

| Filler | Cladding | Diaphragm | Process gas |
|---|---|---|---|
| DLC, C | Si, SiO₂, SiC, | Si, SiO₂, SiC, MgO, ITO, | Inert gas, fluorine-based gas such |
| | MgO, ITO, Ge, | Ge, Ta, TaSi, Ti, TiN, | as CF₄, C₂F₆, C₄F₈, SF₆, and CHF₃ or |
| | Ta, TaSi, Ti, TiN, | TiO₂, Nb, Mo, Zr, W, Al, | gas mixture of one of these gases |
| | TiO₂, Nb, Mo, Zr, W | Mn, Ni, Cu, Cr, Co | and O₂, H₂, or NH₃ or the like |
| | Al, Mn, Ni, Cu, | | Inert gas, or gas mixture of an inert |
| | Cr, Co | | gas and O₂, H₂, or NH₃ or the like |
| Si, SiO₂, SiC, | DLC, C | DLC, C | O₂ gas, H₂ gas, NH₃ gas, or gas |
| MgO, ITO, Ge, | | | mixture of one of these gases, and |
| Ta, TaSi, Ti, TiN, | | | an inert gas, a fluorine-based gas or |
| TiO₂, Nb, Mo, Zr, W | | | the like |
| Al, Mn, Ni, Cu, | | | O₂ gas, H₂ gas, NH₃ gas, fluorine- |
| Cr, Co | | | based gas, or gas mixture of one of |
| | | | these gases and an inert gas |

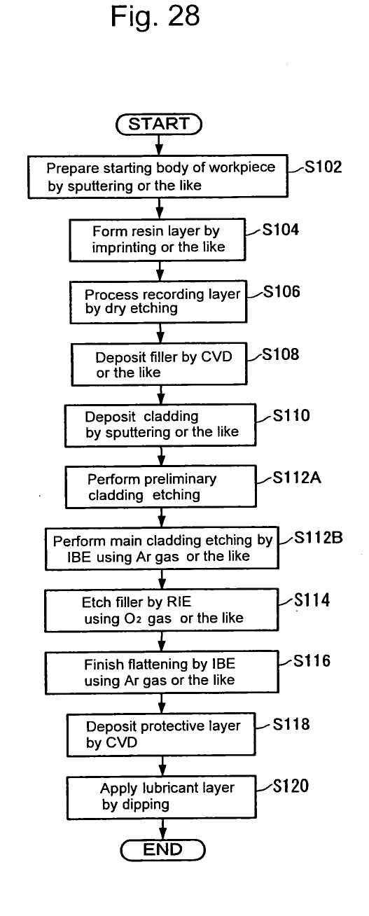

Furthermore, in the first to third exemplary embodiments, the cladding 42 is etched until the filler 36 over the recording elements 20A is exposed and the cladding 42 is further etched by the dry etching method in which the etch rate of the cladding 42 is equal to or higher than the etch rate of the filler 36 in the single-stage cladding etching step (S112). However, as shown in the flowchart of FIG. 28 according to a fourth exemplary embodiment of the present invention, first, in the preliminary cladding etching step (S112A), the cladding 42 may be etched until the filler 36 over the recording elements 20A is exposed. Then, in the main cladding etching step (S112B), the cladding 42 may be etched by the dry etching method in which the etch rate of the cladding 42 is equal to or higher than the etch rate of the filler 36. In the preliminary cladding etching step (S112A), it is acceptable to use the same dry etching method as the dry etching method for the main cladding etching step (S112B) or a dry etching method different from the dry etching method for the main cladding etching step (S112B). However, in the preliminary cladding etching step (S112A), it is preferable to use a dry etching method which provides a higher etch rate for the cladding 42 than in the main cladding etching step (S112B).

Furthermore, as an example of the dry etching method used in the filler etching step (S114) in the first to third exemplary embodiments, the IBE or RIE is shown which uses an O₂ gas, O₃ gas, their plasma, or a gas mixture of any one of them and an inert gas such as or Ar, Kr, Xe, as the process gas. However, it is also possible to use another dry etching method if it allows the etch rate of the filler 36 to be higher than the etch rate of the cladding 42. The same also holds true for the fourth exemplary embodiment. Table 2 shows a preferable combination between the materials of the filler 36, the cladding 42, and the diaphragm 21 (62) and the process gas for the dry etching in the filler etching step (S114).

TABLE 2

| Filler | Cladding | Diaphragm | Process gas |
|---|---|---|---|
| DLC, C | Si, SiO₂, SiC, | Si, SiO₂, SiC, MgO, ITO, | O₂ gas, H₂ gas, NH₃ gas |
| | MgO, ITO, Ge, | Ge, Ta, TaSi, Ti, TiN, | |
| | Ta, TaSi, Ti, TiN, | TiO₂, Nb, Mo, Zr, W, Al, | |
| | TiO₂, Nb, Mo, Zr, W | Mn, Ni, Cu, Cr, Co | |
| | Al, Mn, Ni, Cu, | | O₂ gas, H₂ gas, NH₃ gas, or fluorine- |
| | Cr, Co | | based gas such as CF₄, C₂F₆, C₄F₈, |
| | | | or SF₆ or CHF₃ |
| Si, SiO₂, SiC, | DLC, C | DLC, C | Inert gas |
| MgO, ITO, Ge, | | | |
| Ta, TaSi, Ti, TiN, | | | |
| TiO₂, Nb, Mo, Zr, W | | | |
| Al, Mn, Ni, Cu, | | | |
| Cr, Co | | | |

Furthermore, as an example of the dry etching method used in the finish flattening step (S116) in the first to third exemplary embodiments, the IBE or RIE is shown which uses, as the process gas, an inert gas such as Ar, Kr, or Xe or a gas mixture of one of them and a reactive gas. However, it is also possible to use another dry etching method if it allows the etch rate of the filler 36 to be lower than the etch rate of the cladding 42 or the etch rate of the diaphragm 21 (62) or the recording elements 20A. The same also holds true for the fourth exemplary embodiment. Table 3 shows a preferable combination between the materials of the filler 36, the cladding 42, and the diaphragm 21 (62) and the process gas for the dry etching in the finish flattening step (S116).

TABLE 3

| Filler | Cladding | Diaphragm | Process gas |
|---|---|---|---|
| DLC, C | Si, SiO₂, SiC, | Si, SiO₂, SiC, MgO, ITO, | Inert gas |
| | MgO, ITO, Ge, | Ge, Ta, TaSi, Ti, TiN, | |
| | Ta, TaSi, Ti, TiN, | TiO₂, Nb, Mo, Zr, W, Al, | |
| | TiO₂, Nb, Mo, Zr, W | Mn, Ni, Cu, Cr, Co | |
| | Al, Mn, Ni, Cu, | | |
| | Cr, Co | | |
| Si, SiO₂, SiC, | DLC, C | DLC, C | H₂ gas, NH₃ gas |
| MgO, ITO, Ge, | | | |
| Ta, TaSi, Ti, TiN, | | | |
| TiO₂, Nb, Mo, Zr, W | | | |
| Al, Mn, Ni, Cu, | | | |
| Cr, Co | | | |

Furthermore, by way of example in the first to third exemplary embodiments, the direction of incidence of the process gas in the filler etching step (S114) and the finish flattening step (S116) is shown to be perpendicular to the surface of the workpiece 10. However, the process gas may also be directed to the surface of the workpiece 10 at an angle of incidence to the surface of the workpiece 10. The same also holds true for the fourth exemplary embodiment.

Furthermore, in the finish flattening step (S116) of the first to third exemplary embodiments, the cladding 42 remaining over the concave portion 34 of the concavo-convex pattern of the recording layer 20, and the diaphragm 21 (62) over the recording elements 20A or the vicinity of the top surface of the recording elements 20A are removed. However, the cladding 42 over the concave portion 34 over the concavo-convex pattern of the recording layer 20 or the diaphragm 21 (62) over the recording elements 20A may be removed in the filler etching step (S114). In such a case, the finish flattening step (S116) may be omitted. On the other hand, the cladding 42 over the concave portion 34 of the concavo-convex pattern of the recording layer 20 or the diaphragm 21 (62) over the recording elements 20A may not be removed in the filler etching step (S114). Even in this case, the finish flattening step (S116) may also be omitted if the cladding 42 over the concave portion 34 or the diaphragm 21 (62) over the recording elements 20A can be left in the final product without causing any problem during actual service. Furthermore, the finish flattening step (S116) may be carried out, so that the cladding 42 over the concave portion 34 and/or the diaphragm 21 (62) over the recording elements 20A are left at the end of the finish flattening step (S116) to such an extent that no practical problem will be raised in the final product.

Furthermore, in the first to third exemplary embodiments, the first mask layer 22, the second mask layer 24, and the resin layer 26 are formed over the continuous film recording layer 20, and then the three-stage dry etching is used to divide the recording layer 20 into the concavo-convex pattern. However, no particular limitation is imposed on the material, the number of stacks, and the thicknesses of the mask layers and the resin layer, and the type of dry etching so long as the recording layer 20 can be divided with high accuracy. The same also holds true for the fourth exemplary embodiment.

Furthermore, in the first to third exemplary embodiments, the filler 36 is deposited after the first mask layer 22 remaining over the recording elements 20A is completely removed. However, if the first mask layer 22 and the filler 36 are made of the same material or a similar material, the filler 36 may be deposited over the recording elements 20A with the first mask layer 22 remaining thereon. The similar material may include, for example, DLC which has a different percentage of SP³ hybrid orbital carbon bonds, and DLC and C (carbon) which is not a DLC. The same also holds true for the fourth exemplary embodiment.

Furthermore, in the first to third exemplary embodiments, the soft magnetic layer 16 and the seed layer 18 are formed under the recording layer 20. However, the configuration of the layers under the recording layer 20 may be altered appropriately depending on the type of the magnetic recording medium. For example, it is acceptable to form an underlying layer or an antiferromagnetic layer between the soft magnetic layer 16 and the substrate 12. Or, either one of or both the soft magnetic layer 16 and the seed layer 18 may be eliminated. Alternatively, the recording layer may also be directly formed on the substrate. The same also holds true for the fourth exemplary embodiment.

Furthermore, in the first to third exemplary embodiments, the magnetic recording medium 30 (or 60) is a perpendicular recording type discrete track medium with the recording layer 20 divided at fine intervals radially across the track. However, various exemplary embodiments of the present invention are also applicable to a patterned medium which is divided at fine intervals in both directions, i.e., radially across and circumferentially along the tracks. Various exemplary embodiments of the invention are also applicable to a magnetic disk having a spiral recording layer, a magnetic disk having a recording layer which is separately formed on the top surface of the convex portion and the bottom surface of the concave portion of a concavo-convex patterned underlying layer and which has a portion formed on the top surface of the convex portion as a recording element, a magnetic disk which has recording layer with a concave portion formed halfway thereof in the direction of thickness and continuous at the bottom, and a magnetic disk which has a continuous concavo-convex patterned recording layer that is deposited in a concavo-convex pattern following a concavo-convex pattern of the underlying layer. Various exemplary embodiments of the present invention are also applicable to a magneto-optical disk such as MOs, a heat assisted magnetic disk that employs magnetism and heat in combination, and those magnetic recording media other than disc-shaped ones, such as magnetic tape, which have a recording layer in a concavo-convex pattern. The same also holds true for the fourth exemplary embodiment.

### WORKING EXAMPLE 1

In accordance with the first exemplary embodiment, ten samples of the magnetic recording medium 30 were prepared. More specifically, the recording layer 20 was first processed in the concavo-convex pattern as described below (S106).

Radial pitch of the recording elements 20A: 200 nm

Radial width of the top surface of the recording elements 20A: 100 nm

Depth of the concave portion: 26 nm

It should be noted that the recording layer 20 had a thickness of 20 nm. The recording layer 20 was made of a CoCr alloy. Furthermore, the diaphragm 21 had a thickness of 2 nm. The diaphragm 21 was made of Ta.

Then, the filler 36 was deposited over the concavo-convex pattern by ECR plasma CVD under the following deposition conditions, thereby filling the concave portion 34 with the filler 36 (S108).

Material of the filler 36: DLC

Thickness of the filler 36 deposited: 24 nm

Feed gas: C₂H₄ (ethylene)

Flow rate of feed gas: 80 sccm

Pressure in chamber: 1.06 Pa

Microwave power: 200 W

RF power: 180 W

Vdc (DC voltage effectively applied to the workpiece): −350 V

The filler 36 was also deposited in a concavo-convex pattern following the concavo-convex pattern of the recording layer 20. However, the height difference between the concave and convex portions of the filler 36 was reduced when compared with the height difference between the concave and convex portions of the recording layer 20. The height difference between the concave and convex portions on the surface of the filler 36 was 25 nm. Furthermore, the height of the top surface of the filler 36 that fills the concave portion 34 was generally coincident with the height of the top surface of the recording elements 20A.

Then, the cladding 42 was deposited on the filler 36 by bias sputtering under the deposition conditions stated below (S110).

Material of the cladding 42: Mn

Thickness of the cladding 42 deposited: 15 nm

Source power (Power applied to the target): 500 W

Bias power (Power applied to the workpiece 10): 60 W

Pressure in chamber: 0.3 Pa

Distance between the target and the workpiece 10: 300 mm

The cladding 42 was also deposited in a concavo-convex pattern following the concavo-convex pattern of the recording layer 20. The cladding 42 had a height difference of 25 nm between the surfaces of its concave and convex portions.

Then, the cladding 42 was etched by IBE using an Ar gas as the process gas under the conditions below until the filler 36 over the recording elements 20A was exposed. The cladding 42 was further etched until the height of the top surface of the cladding 42 over the concave portion 34 of the concavo-convex pattern of the recording layer 20 became generally coincident with the height of the top surface of the diaphragm 62 over the recording elements 20A (S112).

Flow rate of Ar gas: 16 sccm

Pressure in chamber: 0.04 Pa

Angle of incidence of process gas: 2 degrees

Beam voltage: 700 V

Beam current: 1100 mA

Suppressor voltage: 520 V

The etching was carried out for two minutes and then stopped at that point in time. The cladding 42 over the recording elements 20A was completely removed. On the other hand, the cladding 42 remained in a thickness of approximately 2 nm over the concave portion 34. The height difference between the concave and convex portions on the surface was 13 nm. It should be noted that under these conditions, the etch rates of the cladding 42 and the filler 36 were as follows.

Material of the cladding 42 (Mn): 0.11 nm/sec

Filler 36 (DLC): 0.11 nm/sec

Then, the excessive filler 36 above the recording elements 20A was removed under the conditions below by IBE using a gas mixture of O₂ gas and Ar gas as the process gas (S114).

Flow rate of O₂ gas: 50 sccm

Flow rate of Ar gas: 3 sccm

Pressure in chamber: 0.08 Pa

Angle of incidence of process gas: 90 degrees

Beam voltage: 500 V

Beam current: 400 mA

Suppressor voltage: 400 V

The etching was carried out for 10 seconds and then stopped at that point in time. The filler 36 above the recording elements 20A was completely removed. On the other hand, the cladding 42 over the concave portion 34 remained. The height difference between the concave and convex portions on the surface was 0.8 nm. It should be noted that under these conditions, the etch rates of the filler 36, the cladding 42, and the diaphragm 62 were as follows.

Filler 36 (DLC): 1.26 nm/sec

Cladding 42 (Mn): 0.10 nm/sec

Diaphragm 21 (Ta): 0.10 nm/sec

Then, the diaphragm 21 over the recording elements 20A and the cladding 42 remaining over the concave portion 34 were removed under the conditions below by IBE using Ar gas as the process gas (S116).

Flow rate of Ar gas: 16 sccm

Pressure in chamber: 0.04 Pa

Angle of incidence of process gas: 90 degrees

Beam voltage: 500 V

Beam current: 500 mA

Suppressor voltage: 400 V

The etching was carried out for 4 seconds and then stopped at that point in time. The diaphragm 21 over the recording elements 20A was completely removed. The cladding 42 over the concave portion 34 was also completely removed. It should be noted that under these conditions, the etch rates of the diaphragm 62, the cladding 42, and the filler 36 were as follows.

Diaphragm 21 (Ta): 0.36 nm/sec

Cladding 42 (Mn): 0.48 nm/sec

Filler 36 (DLC): 0.08 nm/sec

Then, at four portions of each sample obtained in this manner, an AFM (atomic force microscope) was used to measure the height difference between the top surface radially at the center of the recording element 20A and the top surface radially at the center over an adjacent concave portion 34. The arithmetic mean of the height differences of the ten samples was 0.5 nm. That is, it was confirmed that the surface was sufficiently flattened.

### WORKING EXAMPLE 2

In accordance with the second exemplary embodiment, ten samples of the magnetic recording medium 60 were prepared. More specifically, first, the recording layer 20 was processed in the concavo-convex pattern as described below. (S106).

Radial pitch of the recording elements 20A: 200 nm

Radial width of the top surface of the recording elements 20A: 100 nm

Depth of the concave portion: 24 nm

It should be noted that like Working Example 1, the recording layer 20 had a thickness of 20 nm. Furthermore, the recording layer 20 was made of a CoCr alloy.

Then, the diaphragm 62 was deposited by sputtering under the following deposition conditions over the workpiece 50 having the concavo-convex patterned recording layer 20 exposed (S202). The diaphragm 62 was deposited in a concavo-convex pattern following the concavo-convex pattern of the recording layer 20.

Material of the diaphragm 62: TaSi

Thickness of the diaphragm 62 deposited: 2 nm

Source power (Power applied to the target): 500 W

Pressure in chamber: 0.3 Pa

Distance between the target and the workpiece 50: 300 mm

Then, the filler 36 was deposited on the diaphragm 62 by ECR plasma CVD under the following deposition conditions, thereby filling the concave portion 34 with the filler 36 (S108).

Material of the filler 36: DLC

Thickness of the filler 36 deposited: 22 nm

Feed gas: C₂H₄ (ethylene)

Flow rate of feed gas: 80 sccm

Pressure in chamber: 1.06 Pa

Microwave power: 200 W

RF power: 180 W

Vdc (DC voltage effectively applied to the workpiece): −350 V

The filler 36 was also deposited in a concavo-convex pattern following the concavo-convex pattern of the recording layer 20. However, the height difference between the concave and convex portions of the filler 36 was reduced when compared with the height difference between the concave and convex portions of the recording layer 20. The height difference between the surfaces of the concave and convex portions of the filler 36 was 23 nm. Furthermore, the height of the top surface of the filler 36 that fills the concave portion 34 was generally coincident with the height of the top surface of the recording elements 20A.

Then, the cladding 42 was deposited on the filler 36 by bias sputtering under the following deposition conditions (S110).

Material of the cladding 42: SiO₂

Thickness of the cladding 42 deposited: 35 nm

Source power (Power applied to the target): 500 W

Bias power (Power applied to the workpiece 50): 150 W

Pressure in chamber: 0.3 Pa

Distance between the target and the workpiece 50: 250 mm

The cladding 42 was also deposited in a concavo-convex pattern following the concavo-convex pattern of the recording layer 20. The height difference between the surfaces of the concave and convex portions of the cladding 42 was 22 nm.

Then, the cladding 42 was etched under the conditions below by IBE using Ar gas as the process gas until the filler 36 over the recording elements 20A was exposed. The cladding 42 was further etched until the height of the top surface of the cladding 42 over the concave portion 34 of the concavo-convex pattern of the recording layer 20 became generally coincident with the height of the top surface of the diaphragm 62 over the recording elements 20A (S112).

Flow rate of Ar gas: 16 sccm

Pressure in chamber: 0.04 Pa

Angle of incidence of process gas: 2 degrees

Beam voltage: 700 V

Beam current: 1100 mA

Suppressor voltage: 520 V

The etching was carried out for 2 minutes and 15 seconds and then stopped at that point in time. The cladding 42 over the recording elements 20A was completely removed. On the other hand, the cladding 42 remained in a thickness of approximately 2 nm over the concave portion 34. The height difference between the surfaces of the concave and convex portions was 12 nm. It should be noted that under these conditions, the etch rates of the cladding 42 and the filler 36 were as follows.

Cladding 42 (SiO₂): 0.24 nm/sec

Filler 36 (DLC): 0.11 nm/sec

Then, the excessive filler 36 above the recording elements 20A was removed under the conditions below by IBE using a gas mixture of O₂ gas and Ar gas as the process gas (S114).

Flow rate of O₂ gas: 50 sccm

Flow rate of Ar gas: 3 sccm

Pressure in chamber: 0.08 Pa

Angle of incidence of process gas: 90 degrees

Beam voltage: 500 V

Beam current: 400 mA

Suppressor voltage: 400 V

The etching was carried out for 10 seconds and then stopped at that point in time. The filler 36 above the recording elements 20A was completely removed. On the other hand, the cladding 42 over the concave portion 34 remained. The height difference between the surfaces of the concave and convex portions was 0.8 nm. It should be noted that under these conditions, the etch rates of the filler 36, the cladding 42, and the diaphragm 62 were as follows.

Filler 36 (DLC): 1.26 nm/sec

Cladding 42 (SiO₂): 0.10 nm/sec

Diaphragm 62 (TaSi): 0.10 nm/sec

Then, the diaphragm 62 over the recording elements 20A and the cladding 42 remaining over the concave portion 34 were removed under the conditions below by IBE using an Ar gas as the process gas (S116).

Flow rate of Ar gas: 16 sccm

Pressure in chamber: 0.04 Pa

Angle of incidence of process gas: 90 degrees

Beam voltage: 500 V

Beam current: 500 mA

Suppressor voltage: 400 V

The etching was carried out for 4 seconds and then stopped at that point in time. The diaphragm 62 over the recording elements 20A was completely removed. The cladding 42 over the concave portion 34 was also completely removed. It should be noted that under these conditions, the etch rates of the diaphragm 62, the cladding 42, and the filler 36 were as follows.

Diaphragm 62 (TaSi): 0.35 nm/sec

Cladding 42 (SiO₂): 0.43 nm/sec

Filler 36 (DLC): 0.08 nm/sec

Then, at four portions of each sample obtained in this manner, the AFM (atomic force microscope) was used to measure the height difference between the top surface radially at the center of the recording element 20A and the top surface radially at the center over an adjacent concave portion 34. The arithmetic mean of the height differences of the 10 samples was 0.4 nm. That is, it was confirmed that the surface was sufficiently flattened.

### COMPARATIVE EXAMPLE

For a comparison with the aforementioned Working Examples 1 and 2, ten samples of a magnetic recording medium were prepared under modified manufacturing conditions. More specifically, the diaphragm 21 (62) and the cladding 42 were not deposited. Additionally, in the filler deposition step (S108), the filler 36 was deposited in a thickness of 59 nm. It should be noted that this thickness (59 nm) is equal to the total thickness of the diaphragm 21 (62), the filler 36, and the cladding 42 according to Working Examples 1 and 2.

Then, the excessive filler 36 above the recording elements 20A was removed under the conditions below by IBE using Ar gas as the process gas.

Flow rate of Ar gas: 16 sccm

Pressure in chamber: 0.04 Pa

Angle of incidence of process gas: 2 degrees

Beam voltage: 700 V

Beam current: 1100 mA

Suppressor voltage: 520 V

The etching was carried out for 5 minutes and 22 seconds and then stopped at that point in time. The height of the top surface of the filler 36 over the concave portion 34 of the concavo-convex pattern of the recording layer 20 was generally coincident with the height of the top surface of the recording elements 20A. On the other hand, the filler 36 remained over the recording elements 20A. It should be noted that the filler 36 was etched by 35 nm, and the etch rate of the filler 36 under these conditions was 0.11 nm/sec.

Then, as with Working Examples 1 and 2, at four portions of each sample obtained in this manner, the AFM (atomic force microscope) was used to measure the height difference between the top surface radially at the center of the recording element 20A and the top surface radially at the center over an adjacent concave portion 34. The arithmetic mean of the height differences of the 10 samples was 8 nm.

Magnetic recording media with high areal densities, such as discrete track media or patterned media, are expected to have a head flying height of a few nm to a few tens of nm. As described above, in Comparative Example where the filler 36 was etched without depositing the cladding 42, the expected head flying height and the height difference on the surface were about the same degree. In contrast to this, in Working Examples 1 and 2 where the cladding 42 was deposited on the filler 36, and then the cladding 42 and the filler 36 were sequentially etched under the predetermined etching conditions, the height difference on the surface was significantly reduced when compared with the expected head flying height. That is, it was confirmed that the surface could be sufficiently flattened by depositing the cladding on the filler, and then sequentially etching the cladding and the filler under the etching conditions shown in each of the exemplary embodiments.

Various exemplary embodiments of the present invention are applicable to manufacturing a magnetic recording media, such as discrete track media or patterned media, which have a concavo-convex patterned recording layer.

What is claimed is:

1. A method for manufacturing a magnetic recording medium, comprising:
a filler deposition step of depositing a filler over a workpiece to fill a concave portion of a predetermined concavo-convex pattern with the filler, the workpiece having a substrate and a recording layer, the recording layer being formed in the concavo-convex pattern over the substrate so that a convex portion of the concavo-convex pattern constitutes a recording element;
a cladding deposition step of depositing a cladding on the filler;
a preliminary cladding etching step of etching the cladding until the filler over the recording element is exposed;
a main cladding etching step of etching the cladding by a dry etching method in which an etch rate of the cladding is equal to or higher than an etch rate of the filler; and
a filler etching step of etching the filler by a dry etching method in which an etch rate of the filler is higher than an etch rate of the cladding, so that a top surface of the recording element is exposed and the cladding remains over the concave portion of the concavo-convex pattern.

2. The method for manufacturing a magnetic recording medium according to claim 1, further comprising, after the filler etching step, a finish flattening step of etching the cladding and the recording element by a dry etching to remove the cladding remaining over the concave portion of the concavo-convex pattern.

3. The method for manufacturing a magnetic recording medium according to claim 1, wherein at an end of the filler etching step, a height of a top surface of the cladding over the concave portion of the concavo-convex pattern is generally coincident with a height of the top surface of the recording element.

4. The method for manufacturing a magnetic recording medium according to claim 2, wherein at an end of the filler etching step, a height of a top surface of the cladding over the concave portion of the concavo-convex pattern is generally coincident with a height of the top surface of the recording element.

5. The method for manufacturing a magnetic recording medium according to claim 1, wherein at an end of the main cladding etching step, a height of a top surface of the cladding over the concave portion of the concavo-convex pattern is generally coincident with a height of the top surface of the recording element.

6. The method for manufacturing a magnetic recording medium according to claim 2, wherein at an end of the main cladding etching step, a height of a top surface of the cladding over the concave portion of the concavo-convex pattern is generally coincident with a height of the top surface of the recording element.

7. The method for manufacturing a magnetic recording medium according to claim 3, wherein at an end of the main cladding etching step, a height of a top surface of the cladding over the concave portion of the concavo-convex pattern is generally coincident with a height of the top surface of the recording element.

8. A method for manufacturing a magnetic recording medium, comprising:
a filler deposition step of depositing a filler over a workpiece and filling a concave portion of a predetermined concavo-convex pattern with the filler, the workpiece having a substrate, a recording layer, and a diaphragm, the recording layer being formed in the concavo-convex pattern over the substrate so that a convex portion of the concavo-convex pattern constitutes a recording element, the diaphragm being formed at least over a top surface of the recording element in the recording layer;
a cladding deposition step of depositing a cladding on the filler;
a preliminary cladding etching step of etching the cladding until the filler over the recording element is exposed;
a main cladding etching step of etching the cladding by a dry etching method in which an etch rate of the cladding is equal to or higher than an etch rate of the filler; and
a filler etching step of etching the filler by a dry etching method in which an etch rate of the filler is higher than an etch rate of the cladding, so that a top surface of the diaphragm over the recording element is exposed and the cladding remains over the concave portion of the concavo-convex pattern.

9. The method for manufacturing a magnetic recording medium according to claim 8, further comprising, after the filler etching step, a finish flattening step of removing the cladding remaining over the concave portion of the concavo-convex pattern and the diaphragm over the recording element by a dry etching.

10. The method for manufacturing a magnetic recording medium according to claim 8, wherein at an end of the filler etching step, a height of a top surface of the cladding over the concave portion of the concavo-convex pattern is generally coincident with a height of the top surface of the diaphragm over the recording element.

11. The method for manufacturing a magnetic recording medium according to claim 9, wherein at an end of the filler etching step, a height of a top surface of the cladding over the concave portion of the concavo-convex pattern is generally coincident with a height of the top surface of the diaphragm over the recording element.

12. The method for manufacturing a magnetic recording medium according to claim 8, wherein at an end of the main cladding etching step, a height of a top surface of the cladding over the concave portion of the concavo-convex pattern is generally coincident with a height of the top surface of the diaphragm over the recording element.

13. The method for manufacturing a magnetic recording medium according to claim 9, wherein at an end of the main cladding etching step, a height of a top surface of the cladding over the concave portion of the concavo-convex pattern is generally coincident with a height of the top surface of the diaphragm over the recording element.

14. The method for manufacturing a magnetic recording medium according to claim 10, wherein at an end of the main cladding etching step, a height of a top surface of the cladding over the concave portion of the concavo-convex pattern is generally coincident with a height of the top surface of the diaphragm over the recording element.

15. The method for manufacturing a magnetic recording medium according to claim 1, wherein the filler is DLC.

16. The method for manufacturing a magnetic recording medium according to claim 8, wherein the filler is DLC.

17. The method for manufacturing a magnetic recording medium according to claim 1, wherein the main cladding etching step also serves as the preliminary cladding etching step.

18. The method for manufacturing a magnetic recording medium according to claim 8, wherein the main cladding etching step also serves as the preliminary cladding etching step.
